(19) United States
(12) Patent Application Publication
(10) Pub. No.: US 2021/0114410 A1
(43) Pub. Date: Apr. 22, 2021

(54) AXLE ASSEMBLY HAVING A FILL-CHECK ASSEMBLY

(71) Applicant: ArvinMeritor Technology, LLC, Troy, MI (US)

(72) Inventor: Leo Wenstrup, Troy, MI (US)

(73) Assignee: ArvinMeritor Technology, LLC, Troy, MI (US)

(21) Appl. No.: 16/659,919

(22) Filed: Oct. 22, 2019

(51) Int. Cl. B60B 35/16; F01M 11/04

(52) U.S. Cl. CPC B60B 35/16; F01M 2011/0441; F01M 11/04

(57) ABSTRACT

An axle assembly having a fill-check assembly. A fill-check assembly is disposed on the axle housing and may include a fitting, a guard, and a sight glass in fluid communication with a lubricant reservoir via the fitting. The sight glass permits visual inspection of the lubricant in the sight glass.

### TECHNICAL FIELD

This disclosure relates to an axle assembly having a fill-check assembly that permits visual inspection of lubricant.

### BACKGROUND

An axle assembly having a bowl cover with lubricant management features is disclosed in U.S. Pat. No. 10,279,625.

### SUMMARY

In at least one configuration, an axle assembly is provided. The axle assembly may include an axle housing and a fill-check assembly. The axle housing may at least partially define a lubricant reservoir that receives a lubricant. The fill-cheek assembly may be mounted to the axle housing. The fill-check assembly may include a fitting, a guard, and a sight glass. The fitting may be disposed on the axle housing and may be in fluid communication with the lubricant reservoir. The guard may be disposed outside the axle housing. The sight glass may be disposed outside the axle housing and inside the guard. The sight glass may be in fluid communication with the lubricant reservoir via the fitting and may permit visual inspection of the lubricant in the sight glass.

In at least one configuration, an axle assembly is provided. The axle assembly may include an axle housing and a fill-check assembly. The axle housing may at least partially define a lubricant reservoir that receives a lubricant. The fill-check assembly may be disposed on the axle housing. The fill-check assembly may include a fitting, a guard, a sight glass, and a valve. The fitting may be disposed on an exterior surface of the axle housing that is disposed opposite the lubricant reservoir. The guard may be secured to the exterior surface of the axle housing. The sight glass may be disposed outside the axle housing and adjacent to the guard. The sight glass may be in fluid communication with the lubricant reservoir via the valve and may permit visual inspection of the lubricant in the sight glass. The valve may be disposed in the fitting and may control the flow of lubricant between the lubricant reservoir and the sight glass.

### BRIEF DESCRIPTION OF THE DRAWINGS

FIG. 1 is a perspective view of an axle assembly having a fill-check assembly.

FIG. 2 is a partially exploded perspective view of the axle assembly.

FIG. 3 is a perspective view of the fill-check assembly.

FIG. 4 is an exploded perspective view of the fill-check assembly.

FIG. 5 is a cross sectional view along section line 5-5.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

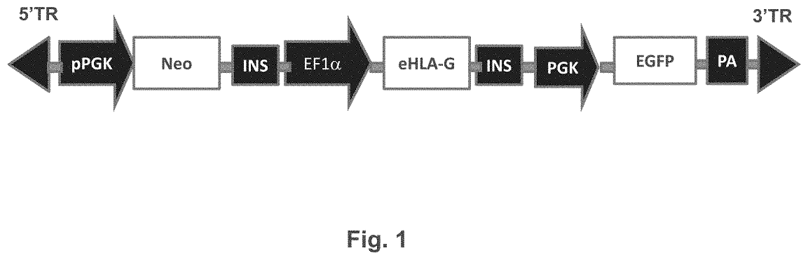

Referring to FIG. 1, an example of an axle assembly 10 is shown. The axle assembly 10 may be provided with a motor vehicle like a truck, bus, farm equipment, mining equipment, military transport or weaponry vehicle, or cargo loading equipment for land, air, or marine vessels. The motor vehicle may include a trailer for transporting cargo in one or more embodiments. The axle assembly 10 may be part of a vehicle drivetrain that may provide torque to one or more traction wheel assemblies that may include a tire mounted on a wheel.

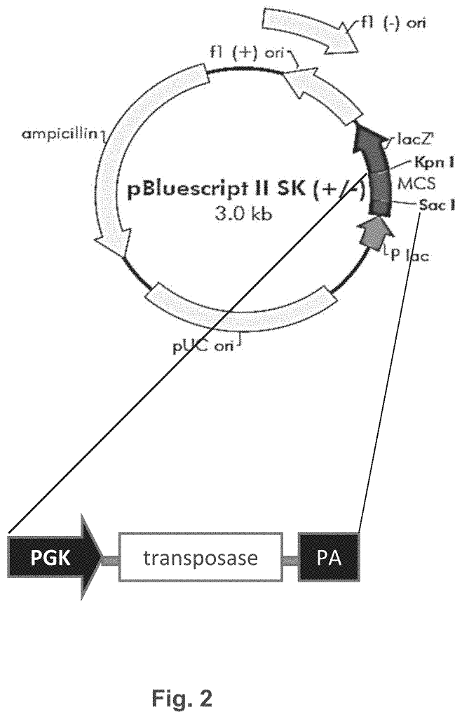

Referring to FIGS. 1 and 2, the axle assembly 10 may receive torque from a power source, such as an electric motor or an internal combustion engine. For example, the power source may be operatively coupled to an input of the axle assembly 10, such as an input yoke 20, in one or more configurations.

One or more axle assemblies 10 may be provided with the vehicle. For example, the axle assembly 10 may be part of a multi-axle configuration that may include a plurality of axle assemblies that may be connected in series. For example, two axle assemblies may be provided in a tandem axle configuration. The first axle assembly or axle assembly that may be first in the series may be referred to as a forward-rear axle assembly. The second axle assembly may be referred to as a rear-rear axle assembly. An output of the first axle assembly may be selectively coupled to an input of the second axle assembly, such as with a prop shaft.

Referring to FIG. 2, the axle assembly 10 may include an axle housing 30, a differential carrier 32, a differential 34, and a fill-check assembly 36.

The axle housing 30 may receive various components of the axle assembly 10. In addition, the axle housing 30 may facilitate mounting of the axle assembly 10 to the vehicle. In at least one configuration, the axle housing 30 may include a center portion 40 and a pair of arm portions 42.

The center portion 40 may be disposed proximate the center of the axle housing 30 and may receive at least a portion of the differential 34. The center portion 40 may define a differential carrier opening 50 and optionally a bowl opening 52.

The differential carrier opening 50 may face toward the differential carrier 32. The differential 34 may be inserted through the differential carrier opening 50 to install the differential 34 into the center portion 40.

The arm portions 42 may extend in opposite lateral directions from the center portion 40. Each arm portion 42 may receive and may rotatable support an axle that may transmit torque from the differential 34 to a corresponding traction wheel assembly.

The axle housing 30 may also include a howl cover 44 that may extend across the bowl opening 52. As such, the bowl cover 44 may be disposed opposite the differential carrier 32 and the differential carrier opening 50. The bowl cover 44 may be integrally formed with the axle housing 30 or may be provided as a separate component. The bowl cover 44 may be directly or indirectly connected to the axle housing 30. For instance, the bowl cover 44 may be directly coupled to the axle housing 30 in any suitable manner, such as with a weld or one or more fasteners, such as bolts. The bowl cover 44 and center portion 40 of the axle housing 30 may cooperate to define a sump portion that may be a lubricant reservoir 60 located at the bottom of the axle housing 30 that may receive and hold lubricant 62.

The differential carrier 32 may support the differential 34. The differential carrier 32 may be mounted on the axle housing 30 proximate the differential carrier opening 50. For example, the differential carrier 32 may be mounted to the axle housing 30 by inserting the differential 34 through the differential carrier opening 50 and positioning the differential carrier 32 against the center portion 40 of the axle housing 30. The differential carrier 32 may be attached to the center portion 40 of the axle housing 30 with a plurality of fasteners, such as bolts.

The differential 34 may be configured to transmit torque to its associated traction wheel assemblies via a pair of axles. The differential 34 may also permit the traction wheel assemblies associated with the axle assembly 10 to rotate at different velocities. An abbreviated description of the differential 34 is provided below to facilitate understanding of the operation of the axle assembly 10 and differential 34.

The power source may be operatively connected to a drive pinion, either directly or via intervening gears. The drive pinion may transmit torque to a ring gear 70 of the differential 34. The ring gear 70 may be fixedly disposed on a differential case of the differential 34 such that the differential case and ring gear 70 may be rotatable about an axis. A differential gear set of the differential 34 may provide torque to the axles in a manner known by those skilled in the art. The axles may transmit torque to corresponding traction wheel assemblies.

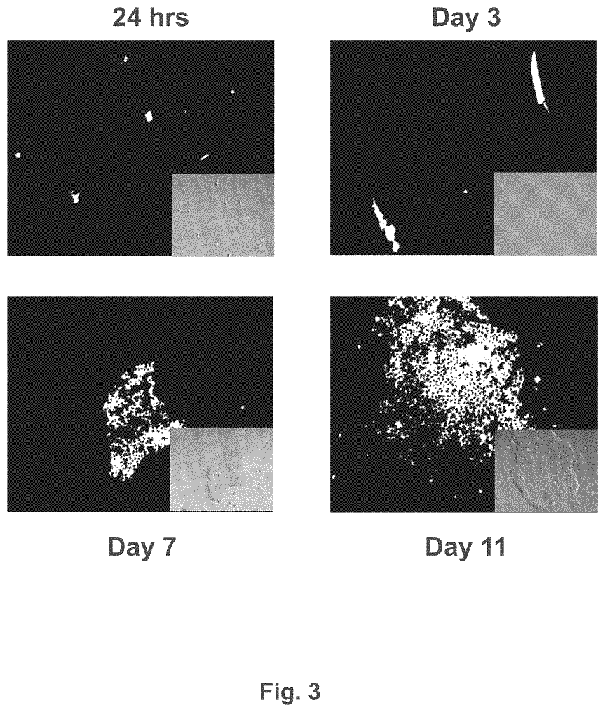

Referring to FIGS. 2 and 3, the fill-check assembly 36 may facilitate visual inspection of the lubricant 62 and the lubricant level in the lubricant reservoir 60. The fill-check assembly 36 may be mounted to the axle housing 30. For example, the fill-check assembly 36 may be mounted to an exterior surface of the axle housing 30 that may be disposed opposite the lubricant reservoir 60. In FIGS. 1 and 2, the fill-check assembly 36 is mounted to the bowl cover 44. In at least one configuration, the fill-check assembly 36 may include a fitting 80, a sight glass 82, a temperature sensor 84, and a guard 86.

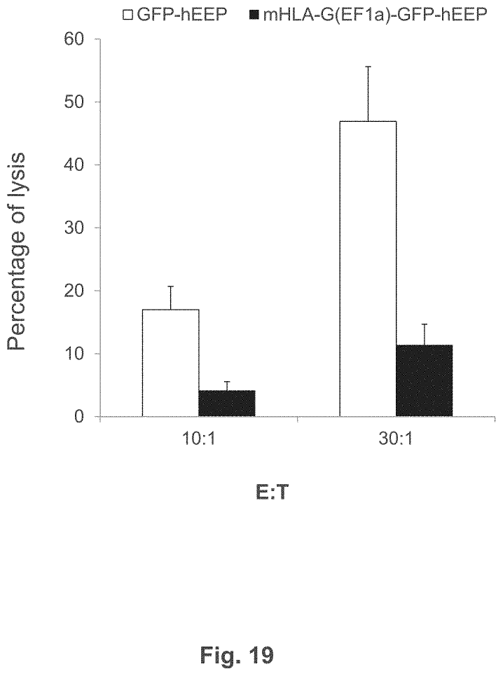

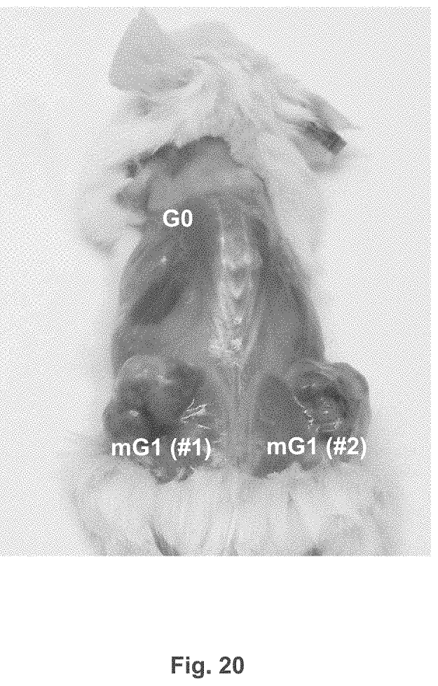

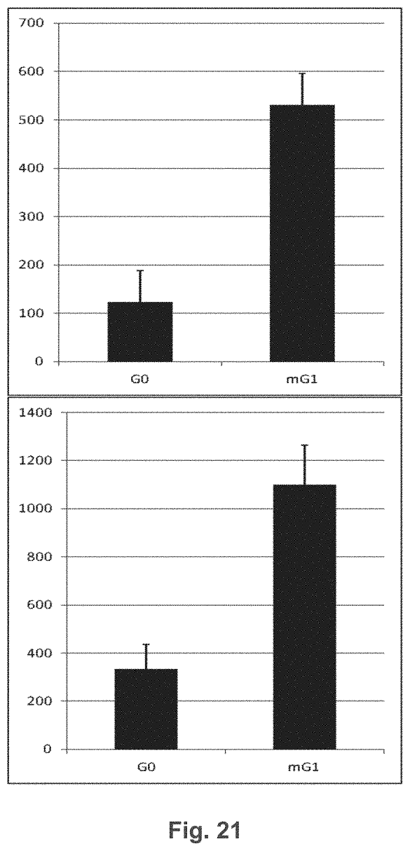

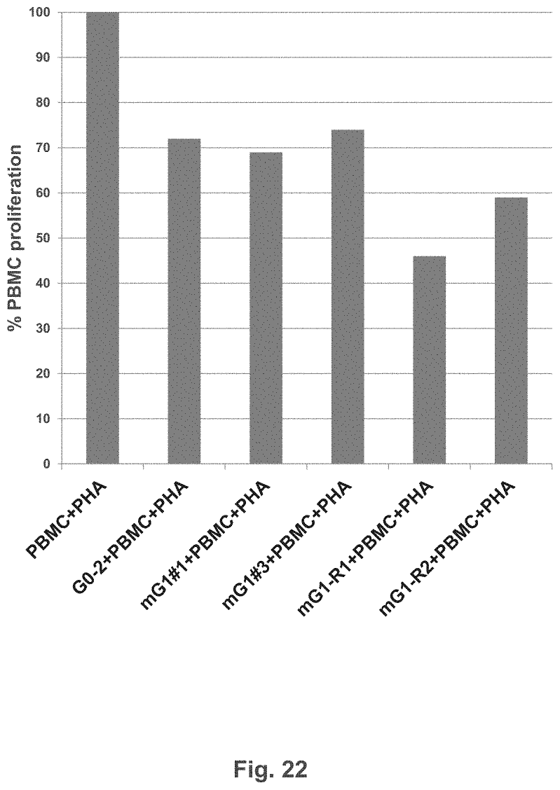

Referring to FIGS. 2 and 3, the fitting 80 may be mounted to the axle housing 30. For instance, the fitting 80 may be fixedly mounted to the bowl cover 44. In at least one configuration, the fitting 80 may include a first nozzle 90, a second nozzle 92, a sensor port 94, and optionally a valve 96, which is best shown in FIG. 5.

Referring to FIG. 2, the first nozzle 90 may be fluidly connected to the lubricant reservoir 60. For instance, the first nozzle 90 may extend through an access hole 98 in the axle housing 30 or portion of the axle housing 30 such as the bowl cover 44 or may be fluidly connected to the lubricant reservoir 60 via the access hole 98. The access hole 98 may be located below a static lubricant level of the lubricant reservoir 60, or below a level that lubricant 62 is expected to reach when the axle assembly 10 is filled with an amount of lubricant specified by the manufacturer. The first nozzle 90 may be secured to the axle housing 30 in any suitable manner, such as through a threaded connection, press-fit, interference-fit, or the like. The first nozzle 90 may be dimensioned to partially or completely extend through the access hole 98.

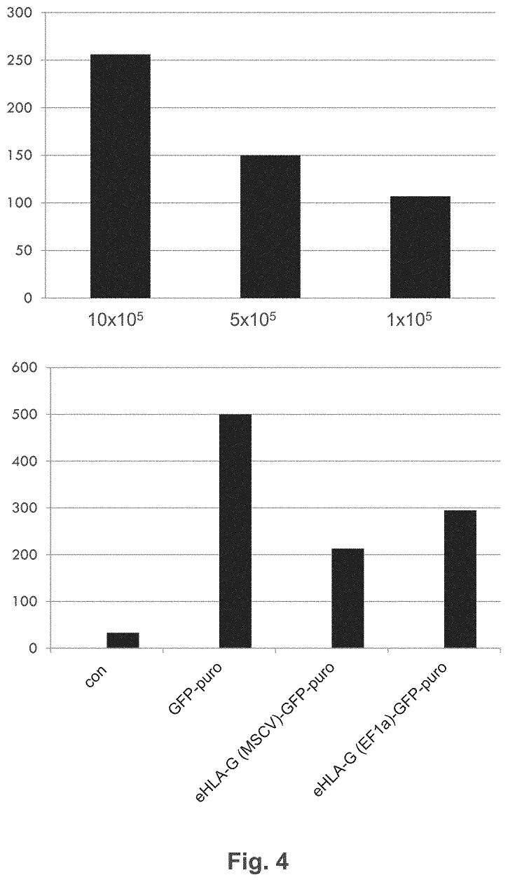

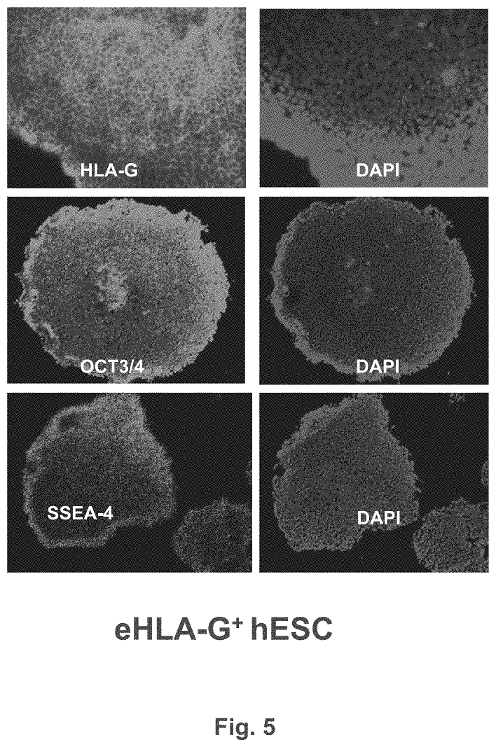

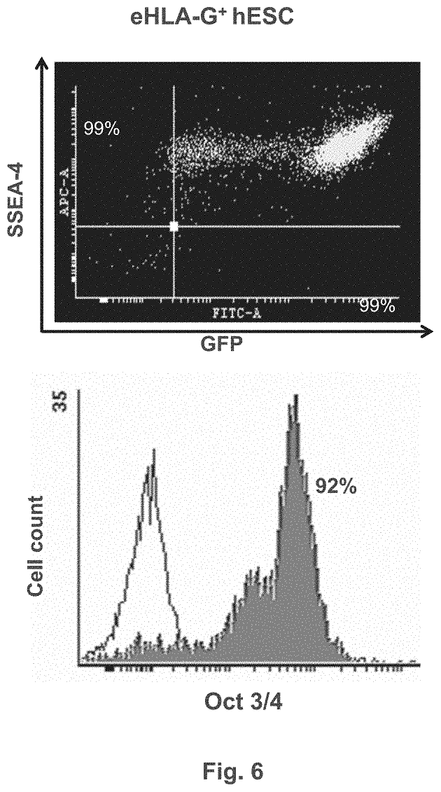

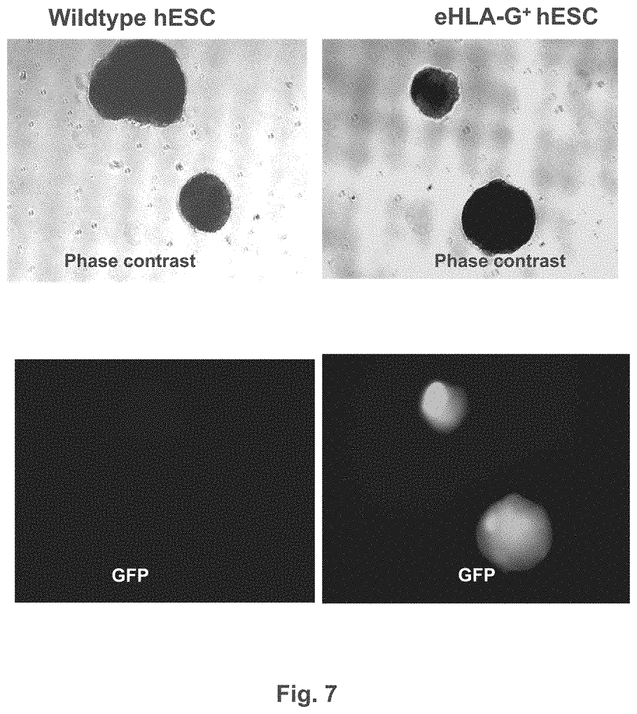

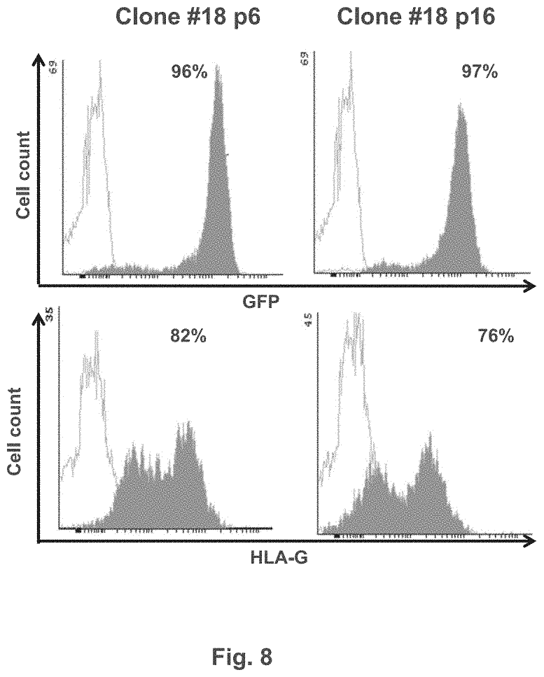

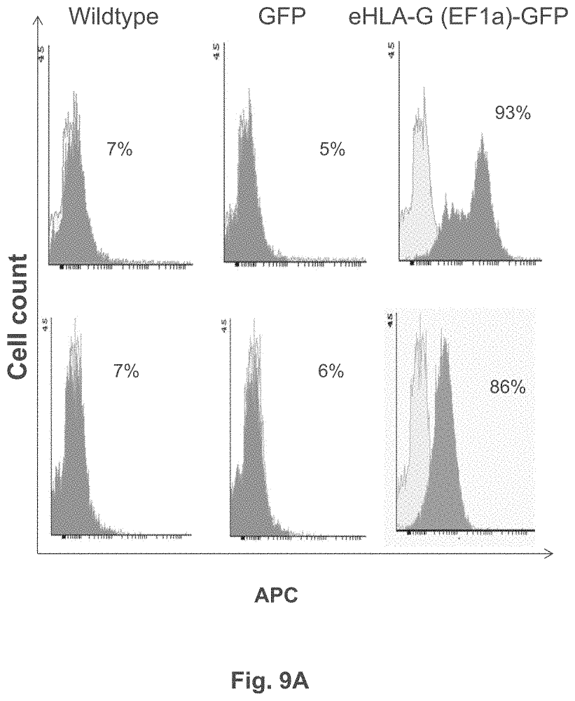

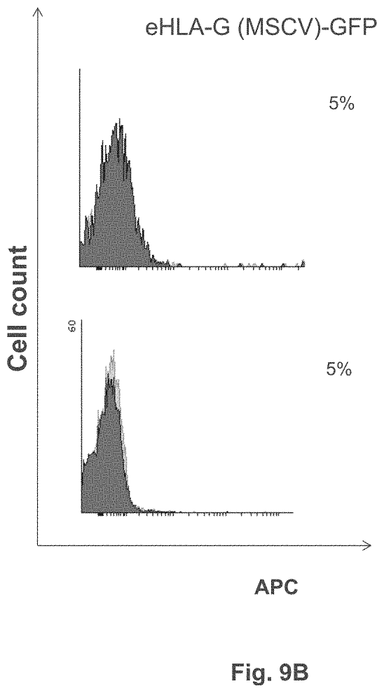

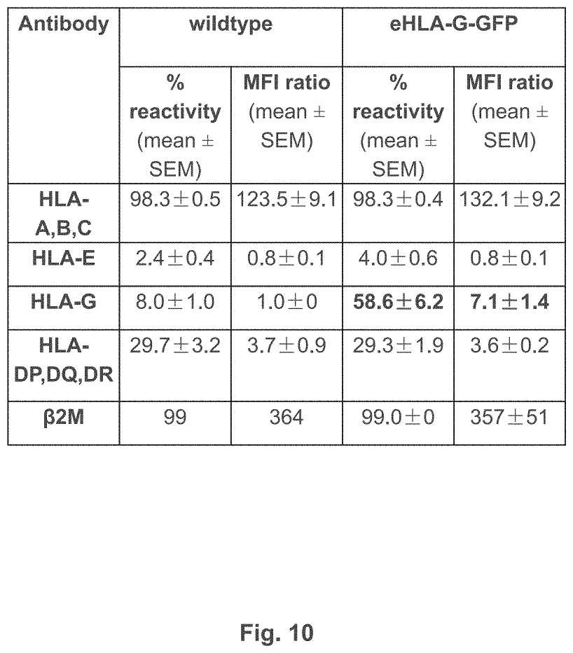

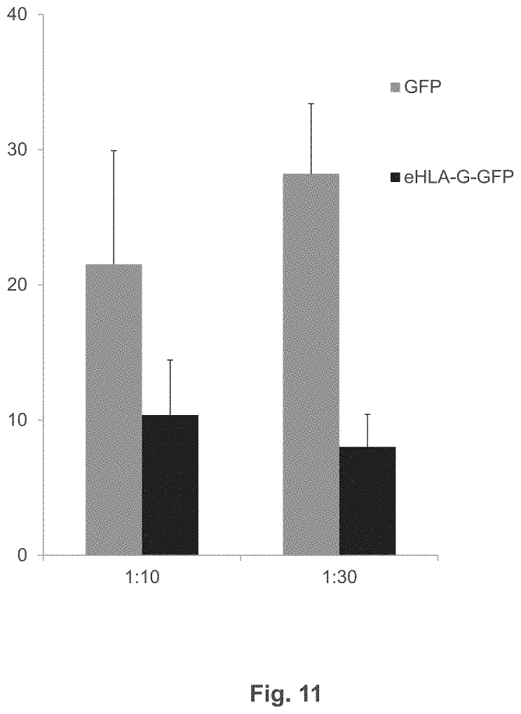

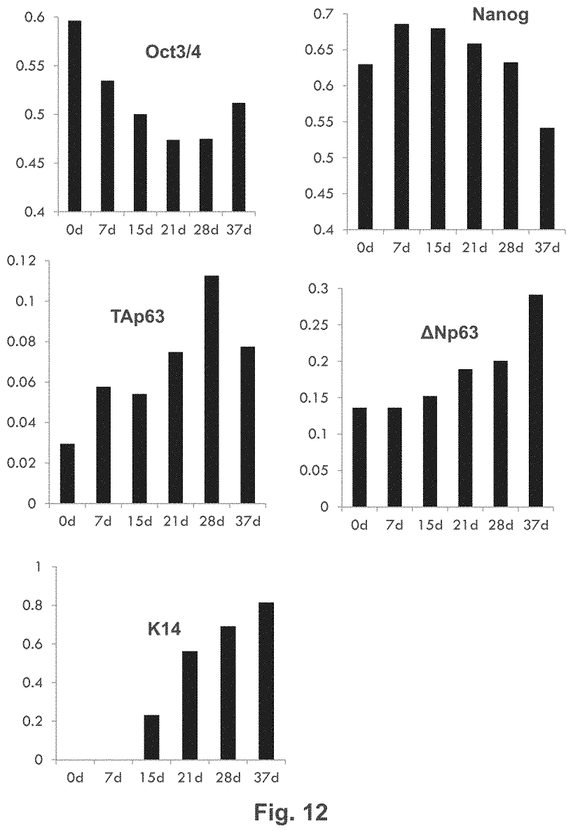

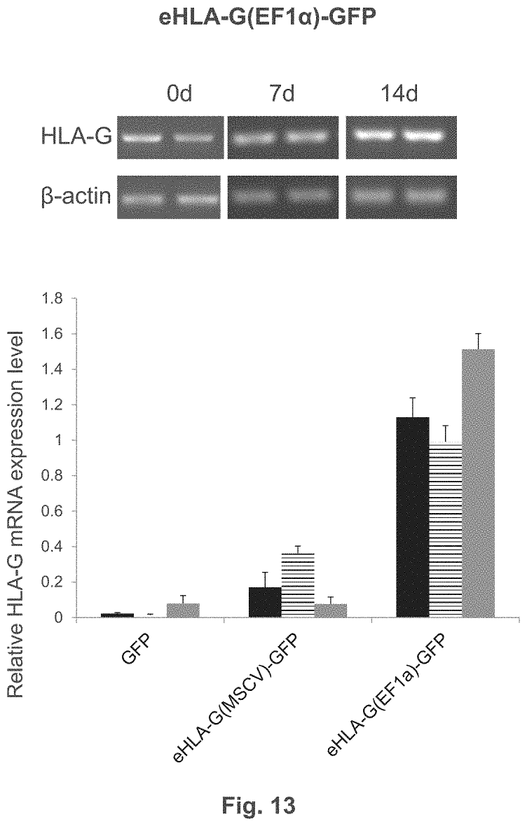

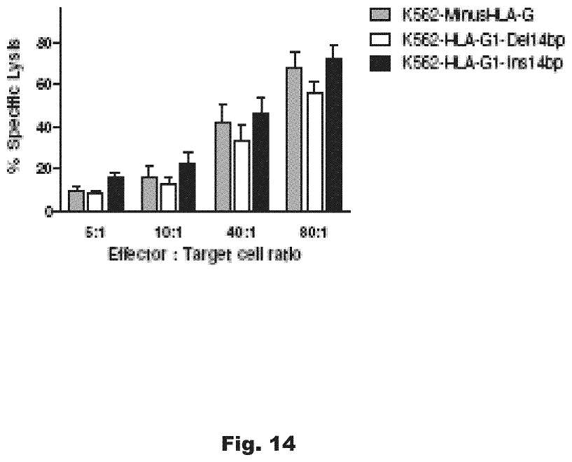

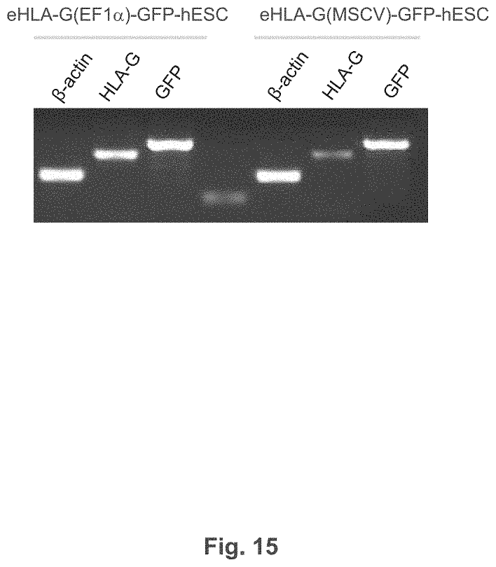

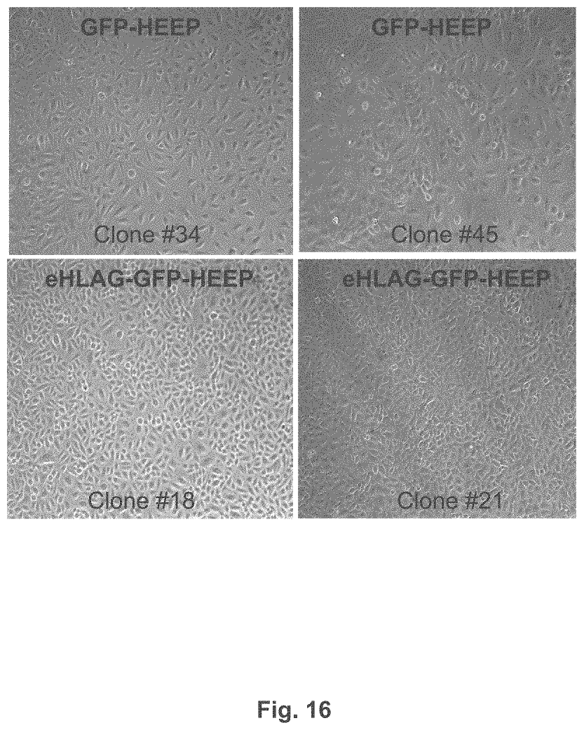

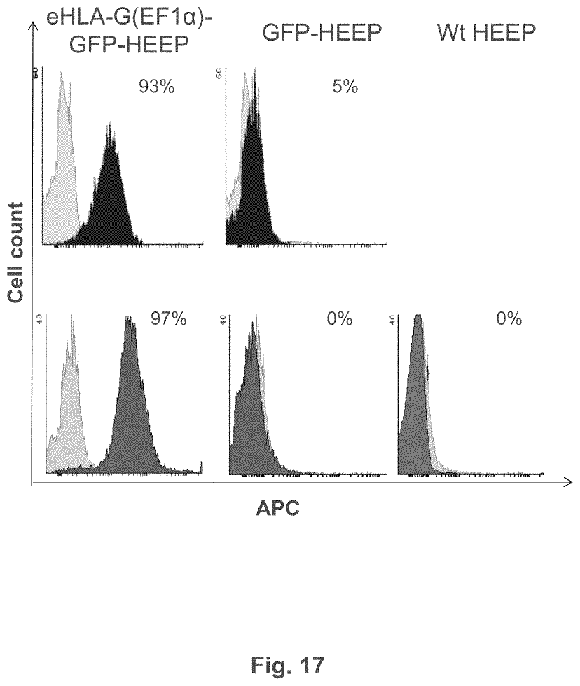

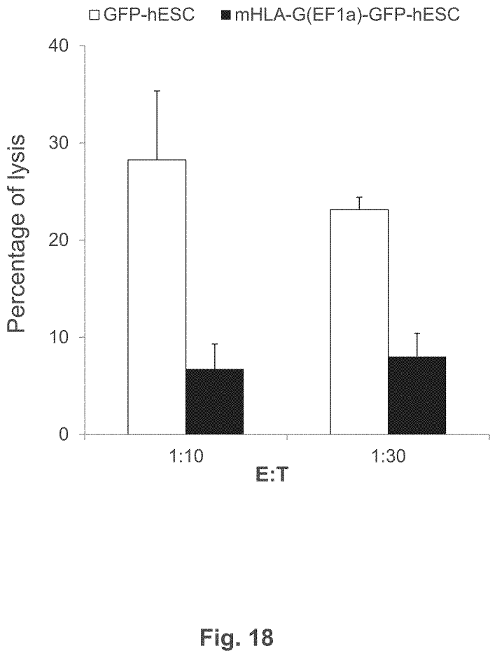

Referring to FIG. 4, the second nozzle 92 may be fluidly connected to first nozzle 90, such as via an interior chamber or interior passage of the fitting 80. The second nozzle 92 may facilitate mounting of the sight glass 82 or providing a fluid connection to the sight glass 82. In at least one configuration, the second nozzle 92 may be disposed substantially perpendicular to the first nozzle 90. Optionally, the second nozzle 92 may include one or more barbs 100 that may facilitate mounting of the sight glass 82. The barbs 100 may be received inside the sight glass 82 or may extend around and receive the sight glass 82 in one or more embodiments.

The sensor port 94 may be fluidly connected to the first nozzle 90, such as via the interior chamber or interior passage of the fitting 80. The sensor port 94 may facilitate mounting of the temperature sensor 84. The sensor port 94 may have any suitable configuration. For instance, the sensor port 94 may be a threaded aperture that may receive and mate with threads on the temperature sensor 84. The sensor port 94 may be coaxially disposed with the first nozzle 90 and may face away or extend away from the axle housing 30. As such, the second nozzle 92 may be positioned between the first nozzle 90 and the sensor port 94. In addition, the sensor port 94 may be coaxially disposed with the first nozzle 90. The sensor port 94 may be omitted in configurations that do not include a temperature sensor 84 or configurations in which the temperature sensor 84 is not mounted to the fitting 80. Alternatively, the sensor port 94 may be provided, but may be sealed with a plug. The temperature sensor 84 may detect the temperature of the lubricant 62 and may be of any suitable type.

Referring to FIG. 5, the valve 96 may be provided with the fitting 80. For instance, the valve 96 may be provided inside the interior chamber or interior passage of the fitting 80 to control the flow of lubricant 62 between the lubricant reservoir 60 and the second nozzle 92. The valve 96 may be disposed between the first nozzle 90 and the sensor port 94. As such, the valve 96 may be disposed outside of the axle housing 30. The valve 96 may be of any suitable type. For instance, the valve 96 may be a ball valve. The valve 96 may be actuated in any suitable manner. For example, the valve 96 may be actuated by pressure exerted by the lubricant 62, a biasing member such as a spring, an electrical or electromechanical actuator such as a motor or solenoid, or combinations thereof.

The valve 96 may be moveable between an open position and a closed position. Examples of the open and closed positions are shown in solid and phantom lines, respectively, in FIG. 5. The valve 96 may permit lubricant 62 to flow into the second nozzle 92 and hence the sight glass 82 when in the open position. The valve 96 may prevent lubricant 62 from flowing into the sight glass 82 when in a closed position. For instance, a valve that may be configured as a ball valve may be spaced apart from a seat surface 110 of the fitting 80 when in the open position and may contact or seal against the seat surface 110 of the fitting 80 when in the closed position. The valve 96 may move from the open position to the closed position to prevent lubricant leakage, such as lubricant leakage from a damaged or improperly sealed sight glass 82. As such, the valve 96 may close or be closed in response to decreased pressure in the sight glass 82 or a lubricant flow rate to the sight glass 82 that pray be indicative of a leak in the sight glass 82 or its cap to prevent lubricant 62 from draining from the axle housing 30.

Referring to FIGS. 3-5, the sight glass 82 may be secured to the second nozzle 92 of the fitting 80. In at least one configuration, the sight glass 82 may include a tubular body 120 and a cap 122.

The tubular body 120 may be configured as a hollow tube and may be cylindrical in one or more embodiments. The tubular body 120 may be transparent material or translucent material to permit visual observation or visual inspection of the lubricant 62 and its level or height in the tubular body 120. The tubular body 120 may be made of any suitable material, such as a polymeric material. The tubular body 120 may have a sufficient length or height such that the cap 122 may be located above a static lubricant level of the axle assembly 10. Lubricant 62 may enter the tubular body 120 when the valve 96 is open and the lubricant level in the lubricant reservoir 60 is at a level that is higher than the bottom of the tubular body 120 and may equalize with the level of the lubricant 62 in the lubricant reservoir 60. Accordingly, the sight glass 82 may provide a visual indication of the lubricant level in the lubricant reservoir 60.

The cap 122 may be disposed at an end of the tubular body 120 that may be disposed opposite the second nozzle 92. The cap 122 may close the end of the tubular body 120 to prevent lubricant 62 from exiting the end of the tubular body 120. The cap 122 may be integrally formed with the tubular body 120 or may be provided as a separate component that is attached to the tubular body 120.

Referring to FIGS. 3-5, the guard 86, which may also be referred to as a sight glass guard, may be mounted to the axle housing 30. For instance, the guard 86 may be mounted to the bowl cover 44 and may be made of a rigid material, such as steel or a polymeric material. The guard 86 may have at least one wall and at least one window that is aligned with the sight glass 82. Opposing ends of the window may delineate a desired lubricant fill range. In at least one configuration, the guard 86 may be generally U-shaped and may include a first side wall 130, a second side wall 132, and an intermediate wall 134. In such a configuration, the sight glass 82 may be received inside the guard 86 between the walls and the axle housing 30. The guard 86 may be open at a top end that is disposed opposite the fitting 80. As such, the guard 86 may also have a top surface 136 disposed opposite the fitting 80. The top surface 136 may be defined by the first side wall 130, the second side wall 132, the intermediate wall 134, or combinations thereof.

The first side wall 130 may be mounted to the axle housing 30. For instance, the first side wall 130 may be fixedly disposed on the exterior surface of the axle housing 30, such as the exterior surface of the bowl cover 44. The first side wall 130 may be spaced apart from the sight glass 82 and optionally may be substantially planar in one or more configurations. The first side wall 130 may define a first window 140.

The first window 140 may be a through hole or transparent portion of the first side wall 130. The first window 140 may be at least partially defined by a lower surface 142 and an upper surface 144. The lower surface 142 may be disposed closer to the fitting 80 than the upper surface 144. The lower surface 142 may designate a minimum lubricant fill level for the axle assembly 10. The upper surface 144 may designate a maximum lubricant fill level for the axle assembly 10 and may be disposed closer to the top surface 136 of the guard 86 than the lower surface 142. The level of lubricant 62 in the lubricant reservoir 60 may be acceptable when the lubricant 62 in the sight glass 82 is disposed between the lower surface 142 and the upper surface 144.

The second side wall 1132 may be mounted to the axle housing 30 and may be disposed opposite the first side wall 130. For instance, the first side wall 130 and the second side wall 132 may be disposed on opposite sides of the sight glass 82 and may be fixedly disposed on the exterior surface of the axle housing 30, such as the exterior surface of the bowl cover 44. The second side wall 132 may be disposed substantially parallel to the first side wall 130. The second side wall 132 may be spaced apart from the sight glass 82 and optionally may be substantially planar in one or more configurations. The second side wall 132 may define a second window 150.

The second window 150 may be a through hole or transparent portion of the first side wall 130. The second window 150 may be at least partially defined by a lower surface 152 and an upper surface 154. The lower surface 152 may be disposed closer to the fitting 80 than the upper surface 154. The lower surface 152 may designate a minimum lubricant fill level for the second type of axle assembly 10. The upper surface 154 may designate a maximum lubricant fill level for the second type of axle assembly and may be disposed closer to the top surface 136 of the guard 86 than the lower surface 152. The level of lubricant 62 in the lubricant reservoir 60 may be acceptable when the lubricant 62 in the sight glass 82 is disposed between the lower surface 152 and the upper surface 154 and the guard 86 is disposed on a second type of axle assembly.

Referring to FIG. 5, the second window 150 may be vertically offset from the first window 140 and may delineate a lubricant fill level range for a second type of axle assembly. For example, the first window 140 may correspond to a “standard efficiency” axle assembly having a first lubricant fill level and the second window 150 may correspond to a “high-efficiency” axle assembly having a second lubricant fill level that is less than the first lubricant fill level. Accordingly, the first window 140 and the second window 150 may allow the fill-check assembly 36 to be standardized and used with different types of axle assemblies that have different lubricant fill levels. For example, the lower surface 142 of the first window 140 may vertically offset above the lower surface 152 of the second window 150 by a distance O1. The upper surface 144 of the first window 140 may be vertically offset above the upper surface 154 of the second window 150 by a distance O2.

Referring to FIGS. 4 and 5, a visual indicator, such as label or symbol, may be provided with each side wall to help identify the type of axle assembly associated with a window. For example, the first visual indicator 160, such as the letters “STD” may be provided with the first side wall 130 to designate that the first window 140 is used to visually assess the lubricant fill level of a “standard efficiency” axle assembly, while a second visual indicator 162, such as the letters “HE” may be provided with the second side wall 132 to designate that the second window 150 is used to visually assess the lubricant fill level of a “high-efficiency” axle assembly that may receive less lubricant as compared to a standard efficiency axle assembly in accordance with manufacture specifications. The visual indicators may be provided (e.g., formed, stamped, adhered, applied) during manufacture of the guard 86, or may be provided after manufacture of the guard 86.

The intermediate wall 134 may connect the first side wall 130 and the second side wall 132. For instance, the intermediate wall 134 may be spaced apart from the axle housing 30 and may extend from an end of the first side wall 130 to an end of the second side wall 132. As such, the sight glass 82 may be disposed between and may be spaced apart from the axle housing 30 and the intermediate wall 134, thereby creating an air gap around the sight glass 82 with respect to the axle housing 30 and the guard 86. The air gap may help protect the sight glass 82 from damage if an object contacts or hits the guard 86.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An axle assembly comprising:
an axle housing that at least partially defines a lubricant reservoir that receives a lubricant; and
a fill-check assembly that is mounted to the axle housing, the fill-check assembly including:
a fitting that is disposed on the axle housing and is in fluid communication with the lubricant reservoir;
a guard that is disposed outside the axle housing and that defines a first window and a second window, wherein the first window is partially defined by a lower surface and an upper surface that is disposed opposite the lower surface, the second window is partially defined by a second lower surface and a second upper surface that is disposed opposite the second lower surface, the lower surface is disposed closer to the fitting than the second lower surface, the upper surface is disposed closer to the fitting than the second upper surface, and the second lower surface is disposed closer to the fitting than the upper surface; and
a sight glass that is disposed outside the axle housing and inside the guard, wherein the sight glass is in fluid communication with the lubricant reservoir via the fitting and permits visual inspection of the lubricant in the sight glass.

2. The axle assembly of claim 1 wherein the sight glass is spaced apart from the guard.

3. The axle assembly of claim 1 wherein the guard is disposed on an exterior surface of the axle housing and a level of lubricant in the lubricant reservoir is acceptable when the lubricant in the sight glass is visible through the first window.

4. The axle assembly of claim 1 wherein a level of lubricant in the lubricant reservoir is acceptable when the lubricant in the sight glass is disposed between the lower surface and the upper surface.

5. The axle assembly of claim 1 wherein the upper surface is disposed above the lower surface and is disposed parallel to the lower surface.

6. The axle assembly of claim 5 wherein a level of lubricant in the lubricant reservoir is acceptable when the lubricant in the sight glass is visible through the second window.

7. The axle assembly of claim 6 wherein the guard has a first wall and a second wall disposed on opposite sides of the sight glass, wherein the first window is defined by the first wall and the second window is defined by the second wall.

8. The axle assembly of claim 7 wherein the first wall and the second wall extend from an exterior surface of the axle housing.

9. The axle assembly of claim 8 wherein the guard has a top surface and the upper surface of the first window is disposed closer to the top surface than the second upper surface of the second window.

10. The axle assembly of claim 1 wherein the sight glass is a formed of a transparent material or translucent material to permit visual observation of the sight glass.

11. An axle assembly comprising:
an axle housing that at least partially defines a lubricant reservoir that receives a lubricant; and
a fill-check assembly that is disposed on the axle housing and includes:
a fitting that disposed on an exterior surface of the axle housing that is disposed opposite the lubricant reservoir, wherein the fitting is in fluid communication with the lubricant reservoir;
a guard that is secured to the exterior surface of the axle housing and that has a first wall that defines a first window, a second wall that is spaced apart from the first wall and that defines a second window, wherein the first window is partially defined by a lower surface and an upper surface that is disposed opposite the lower surface, the second window is partially defined by a second lower surface and a second upper surface that is disposed opposite the second lower surface, the lower surface is disposed closer to the fitting than the second lower surface, the upper surface is disposed closer to the fitting than the second upper surface, and the second lower surface is disposed closer to the fitting than the upper surface, wherein the first window is the only window in the first wall and the second window is the only window in the second wall;
a sight glass that is disposed outside the axle housing and adjacent to the guard and permits visual inspection of the lubricant in the sight glass; and
a valve disposed in the fitting that controls flow of the lubricant between the lubricant reservoir and the sight glass.

12. The axle assembly of claim 11 wherein the axle housing has a bowl cover that is disposed opposite a differential carrier and the bowl cover has the exterior surface.

13. The axle assembly of claim 11 wherein the fitting includes a first nozzle that extends through the axle housing to the lubricant reservoir and a second nozzle that is fluidly connected to the first nozzle, wherein the sight glass is secured to the second nozzle.

14. The axle assembly of claim 11 wherein the guard has an intermediate wall that is disposed opposite the axle housing and that extends from an end of the first wall to an end of the second wall and the sight glass is disposed in the guard between the first wall, the second wall, and the intermediate wall.

15. The axle assembly of claim 13 wherein the fitting includes a sensor port disposed opposite the first nozzle.

16. The axle assembly of claim 15 further comprising a temperature sensor secured to the sensor port, wherein the temperature sensor detects temperature of the lubricant.

17. The axle assembly of claim 15 wherein the valve is disposed inside the fitting and outside the axle housing.

18. The axle assembly of claim 17 wherein the valve is disposed between the first nozzle and the sensor port.

19. The axle assembly of claim 17 wherein the valve permits lubricant to flow into the sight glass when in an open position and the valve prevents the lubricant from flowing into the sight glass when in a closed position.

20. The axle assembly of claim 19 wherein the valve moves from the open position to the closed position to prevent lubricant from leaking from the sight glass.
